(19) United States
(12) Patent Application Publication
(10) Pub. No.: US 2026/0323665 A1
(43) Pub. Date: Oct. 15, 2026

(54) DEVICES AND METHODS FOR COMMUNICATION

(71) Applicant: NEC Corporation, Tokyo (JP)

(72) Inventors: You LI, Beijing (CN); Gang WANG, Beijing (CN)

(73) Assignee: NEC Corporation, Tokyo (JP)

(21) Appl. No.: 19/483,395

(22) PCT Filed: May 11, 2023
(86) PCT No.: PCT/CN2023/093654

§ 371 Date: Nov. 11, 2025

(51) Int. Cl. H04W 72/25; H04W 24/04; H04W 72/02; H04W 72/0453; H04W 76/14

(52) U.S. Cl. CPC H04W 72/25; H04W 24/04; H04W 72/02; H04W 72/0453; H04W 76/14

(57) ABSTRACT

Embodiments of the present disclosure provide a solution for carrier aggregation (CA) in (SL) communication. In the solution, a first terminal device determines a set of resources on at least one frequency to be used for a sidelink (SL) transmission between the first terminal device and a second terminal device. The first terminal device is configured with more than one frequency. The SL transmission comprises at least one of the following: a signal radio bear (SRB) transmission, a physical sidelink feedback channel (PSFCH) transmission or a medium access control (MAC) control element (CE) transmission. The first terminal device performs the SL transmission with the second terminal device on the set of resources.

### FIELDS

Example embodiments of the present disclosure generally relate to the field of communication techniques and in particular, to devices and methods for carrier aggregation (CA) in sidelink (SL) communication.

### BACKGROUND

With the development of communication techniques, a variety of communication networks have been developed or studied. In some wireless communication networks, in addition to communicating with base stations via access links, user equipments (UEs) can communicate with other devices using a sidelink (e.g., a communication link between a UE and another UE) as well. Such communication may relate to, for example, vehicle-based communication devices that can communicate from vehicle-to-vehicle (V2V), vehicle-to-infrastructure (V2I) (e.g., from the vehicle-based communication device to road infrastructure nodes), vehicle-to-network (V2N) (e.g., from the vehicle-based communication device to one or more network nodes, such as a base station), a combination thereof and/or with other devices, which can be collectively referred to as vehicle-to-anything (V2X) communications. Further improvements in techniques related to the sidelink communication are desired.

### SUMMARY

In a first aspect, there is provided a communication method performed by a first terminal device. The method comprises: determining a set of resources on at least one frequency to be used for a sidelink (SL) transmission between the first terminal device and a second terminal device, the first terminal device being configured with more than one frequency, the SL transmission comprising at least one of the following: a signal radio bear (SRB) transmission, a physical sidelink feedback channel (PSFCH) transmission or a medium access control (MAC) control element (CE) transmission; and performing, with the second terminal device, the SL transmission on the set of resources.

In a second aspect, there is provided a communication method performed by a network device. The method comprises: generating a configuration indicating a set of resources on at least one frequency to be used for a sidelink (SL) transmission between a first terminal device and a second terminal device, the SL transmission comprising at least one of the following: a signal radio bear (SRB) transmission, a physical sidelink feedback channel (PSFCH) transmission or a medium access control (MAC) control element (CE) transmission; and transmitting, the configuration to the first terminal device.

In a third aspect, there is provided a communication method performed by a first terminal device. The method comprises: prior to performing a packet data convergence protocol (PDCP) duplication transmission with a second terminal device, transmitting resource information to the second terminal device, the resource information indicating at least one of the following first resources used by the first terminal device for a physical sidelink feedback channel (PSFCH) transmission, second resources used by the first terminal device to perform the PDCP duplication transmission, third resources on which the first terminal device expects to receive a PSFCH transmission, or a mapping of an original radio link control (RLC) channel and a duplicated RLC channel; and performing, based at least in part on the resource information, the PDCP duplication transmission with the second terminal device.

In a fourth aspect, there is provided a communication method performed by a second terminal device. The method comprises: prior to performing a packet data convergence protocol (PDCP) duplication transmission with a first terminal device, receiving resource information from the first terminal device, the resource information indicating at least one of the following: first resources used by the first terminal device for a transmitting physical sidelink feedback channel (PSFCH) transmission; or second resources used by the first terminal device to transmit the PDCP duplication transmission; third resources on which the first terminal device expects to receive a PSFCH transmission; or a mapping of an original radio link control (RLC) channel and a duplicated RLC channel; and performing, based at least in part on the resource information, the PDCP duplication transmission with the first terminal device.

In a fifth aspect, there is provided a communication method performed by a network device. The method comprises: receiving feedback information from a first terminal device, the feedback information indicating at least one of the following: whether first resources used by the first terminal device for a transmitting physical sidelink feedback channel (PSFCH) transmission of a packet data convergence protocol (PDCP) duplication transmission are confirmed or rejected by the second terminal device, whether the second resources used by the first terminal device to transmit the PDCP duplication transmission are confirmed or rejected by the second terminal device, third resources comprised in the first resources that are confirmed or rejected by the second terminal device, or fourth resources comprised in the second resources that are confirmed or rejected by the second terminal device.

In a sixth aspect, there is provided a communication method performed by a first terminal device. The method comprises: performing, with a second terminal device, a sidelink (SL) transmission on a plurality of frequencies; and triggering a selection of a frequency of the plurality of frequencies if one of the following: the number of negative acknowledgement (NACK) associated with the frequency is larger than or equal to a first threshold number, a first channel busy ratio (CBR) value associated with the frequency measured by the first terminal device is larger than or equal to a first threshold value, a second CBR value associated with the frequency measured by the second terminal device is larger than or equal to a second threshold value.

In a seventh aspect, there is provided a communication method performed by a first terminal device. The method comprises: determining at least one frequency to be used by the first terminal device for a sidelink (SL) transmission with a second terminal device based on at least one of the following: a first set of frequencies supported by the first terminal device, a second set of frequencies supported by the second terminal device, a first set of channel busy ratio (CBR) measurement results associated with at least part of the first set of frequencies, or a second set of CBR measurement results associated with at least part of the second set of frequencies; and performing, with the second terminal device, the SL communication on the at least one frequency.

In an eighth aspect, there is provided a first terminal device comprising: a processor configured to cause the first terminal device to: determine a set of resources on at least one frequency to be used for a sidelink (SL) transmission between the first terminal device and a second terminal device, the first terminal device being configured with more than one frequency, the SL transmission comprising at least one of the following: a signal radio bear (SRB) transmission, a physical sidelink feedback channel (PSFCH) transmission or a medium access control (MAC) control element (CE) transmission; and perform, with the second terminal device, the SL transmission on the set of resources.

In a ninth aspect, there is provided a network device comprising: a processor configured to cause the network device to: generate a configuration indicating a set of resources on at least one frequency to be used for a sidelink (SL) transmission between a first terminal device and a second terminal device, the SL transmission comprising at least one of the following: a signal radio bear (SRB) transmission, a physical sidelink feedback channel (PSFCH) transmission or a medium access control (MAC) control element (CE) transmission; and transmit, the configuration to the first terminal device.

In a tenth aspect, there is provided a first terminal device comprising: a processor configured to cause the first terminal device to: prior to performing a packet data convergence protocol (PDCP) duplication transmission with a second terminal device, transmit resource information to the second terminal device, the resource information indicating at least one of the following first resources used by the first terminal device for a physical sidelink feedback channel (PSFCH) transmission, second resources used by the first terminal device to perform the PDCP duplication transmission, third resources on which the first terminal device expects to receive a PSFCH transmission, or a mapping of an original radio link control (RLC) channel and a duplicated RLC channel; perform, based at least in part on the resource information, the PDCP duplication transmission with the second terminal device.

In an eleventh aspect, there is provided a second terminal device comprising: a processor configured to cause the second terminal device to: prior to performing a packet data convergence protocol (PDCP) duplication transmission with a first terminal device, receive resource information from the first terminal device, the resource information indicating at least one of the following: first resources used by the first terminal device for a transmitting physical sidelink feedback channel (PSFCH) transmission; or second resources used by the first terminal device to transmit the PDCP duplication transmission; third resources on which the first terminal device expects to receive a PSFCH transmission; or a mapping of an original radio link control (RLC) channel and a duplicated RLC channel; and perform, based at least in part on the resource information, the PDCP duplication transmission with the first terminal device.

In a twelfth aspect, there is provided a network device comprising: a processor configured to cause the network device to: receive feedback information from a first terminal device, the feedback information indicating at least one of the following: whether first resources used by the first terminal device for a transmitting physical sidelink feedback channel (PSFCH) transmission of a packet data convergence protocol (PDCP) duplication transmission are confirmed or rejected by the second terminal device, whether the second resources used by the first terminal device to transmit the PDCP duplication transmission are confirmed or rejected by the second terminal device, third resources comprised in the first resources that are confirmed or rejected by the second terminal device, or fourth resources comprised in the second resources that are confirmed or rejected by the second terminal device.

In a thirteenth aspect, there is provided a first terminal device comprising: a processor configured to cause the first terminal device to: perform, with a second terminal device, a sidelink (SL) transmission on a plurality of frequencies; and trigger a selection of a frequency of the plurality of frequencies if one of the following: the number of negative acknowledgement (NACK) associated with the frequency is larger than or equal to a first threshold number, a first channel busy ratio (CBR) value associated with the frequency measured by the first terminal device is larger than or equal to a first threshold value, a second CBR value associated with the frequency measured by the second terminal device is larger than or equal to a second threshold value.

In a fourteenth aspect, there is provided a first terminal device comprising: a processor configured to cause the first terminal device to: determine at least one frequency to be used by the first terminal device for a sidelink (SL) transmission with a second terminal device based on at least one of the following: a first set of frequencies supported by the first terminal device, a second set of frequencies supported by the second terminal device, a first set of channel busy ratio (CBR) measurement results associated with at least part of the first set of frequencies, or a second set of CBR measurement results associated with at least part of the second set of frequencies; and perform, with the second terminal device, the SL communication on the at least one frequency.

In a fifteenth aspect, there is provided a computer readable medium having instructions stored thereon, the instructions, when executed on at least one processor, causing the at least one processor to carry out the method according to the first, second, third, fourth, fifth, sixth, or seventh aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication environment in which example embodiments of the present disclosure can be implemented;

FIG. 2 illustrates a signaling flow of an SL communication configured with more than one frequency in accordance with some embodiments of the present disclosure;

FIG. 3 illustrates a signaling flow of a PDCP duplication communication in accordance with some embodiments of the present disclosure;

FIG. 4 illustrates a signaling flow of a reselection procedure for SL communication in accordance with some embodiments of the present disclosure;

FIG. 5 illustrates a signaling flow of a frequency selection procedure for an SL communication in accordance with some embodiments of the present disclosure;

FIG. 6 illustrates a flowchart of a method implemented at a first terminal device according to some example embodiments of the present disclosure;

FIG. 7 illustrates a flowchart of a method implemented at a network device according to some example embodiments of the present disclosure;

FIG. 8 illustrates a flowchart of a method implemented at a first terminal device according to some example embodiments of the present disclosure;

FIG. 9 illustrates a flowchart of a method implemented at a second terminal device according to some example embodiments of the present disclosure;

FIG. 10 illustrates a flowchart of a method implemented at a network device according to some example embodiments of the present disclosure;

FIG. 11 illustrates a flowchart of a method implemented at a first terminal device according to some example embodiments of the present disclosure;

FIG. 12 illustrates a flowchart of a method implemented at a first terminal device according to some example embodiments of the present disclosure; and

FIG. 13 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IOT) devices, Ultra-reliable and Low Latency Communications (URLLC) devices, Internet of Everything (IoE) devices, machine type communication (MTC) devices, devices on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and play back appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and may be used to predict some information.

The terminal or the network device may work on several frequency ranges, e.g., FRI (e.g., 450 MHz to 6000 MHz), FR 2 (e.g., 24.25 GHz to 52.6 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, channel emulator. In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As used herein, the term “resource,” “transmission resource,” “uplink resource,” or “downlink resource” may refer to any resource for performing a communication, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

In conventional SL communications, for example, during transmission of the SRB 0/1/2 transmission, peer UEs cannot know the carrier list configuration exactly. Therefore, the transmission reliability cannot be ensured by the negotiation of peer UEs. Instead, it should rely on network configuration to align the SRB0/1/2 transmission of Tx UE (or a transmitter) and reception of Rx UE (or a receiver).

Moreover, for an SL communication has a CA architecture, there are quite a few issues to be solved, for example, how to perform SRB0/1/2 transmission under the CA architecture, how to perform Physical sidelink feedback channel (PSFCH) transmission under the CA architecture, how to perform carrier selection/reselection for unicast, and so on.

In view of the above and other potential issues, embodiments of the present disclosure propose solutions related to the SL SRB0/1/2 transmission, the PSFCH transmission, and/or carrier selection/reselection for unicast in the SL communications. Principles and implementations of the present disclosure will be described in detail below with reference to the figures.

In the present discourse, the term “frequency” may refer to a frequency range in frequency domain. In the following, a carrier will be used as an example of the frequency for describing some specific example embodiments of the present disclosure. It is noted that in the other embodiments, the frequency may be a frequency band, a frequency band group, a carrier group and the likes. In present discourse is not limited in this regard.

In the present discourse, the SL terminal devices are equivalent with each other. In view of this, in the following, a first/second terminal device will be used as an example of the SL terminal device for describing some specific example embodiments of the present disclosure. It is noted that example embodiments described with regard to the first/second terminal device are equally applicable to the other SL terminal device(s). Merely for brevity, the same or the similar are omitted.

In the present discourse, description of “transmission between the first terminal device and the second terminal device” may refer to a unicast transmission between the first terminal device and the second terminal device.

In the present discourse, term “perform a transmission” may refer to “receive a transmission” and/or “transmit a transmission”. Specifically, “A performs a transmission with B” may refer to “A receives a transmission from B” and/or “A transmits a transmission to B”.

In the present discourse, there may be a mapping (such as, one to one mapping) among the RLC channel, RLC entity, logical channel identification (LCID), carrier, path (also may referred to as transmission leg). In view of this, these above mentioned terms may be used interchangeably.

In the present discourse, terms “selection” and “reselection” may be used interchangeably. For example, “resource/carrier reselection” may be replaced by “resource/carrier selection”, and vice versa.

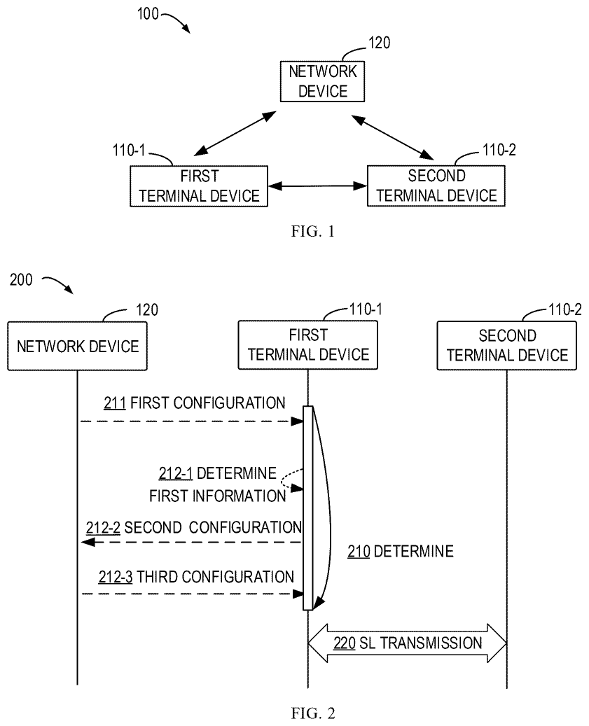

FIG. 1 illustrates a schematic diagram of an example communication environment 100 in which example embodiments of the present disclosure can be implemented. In the communication environment 100, a plurality of communication devices, including a first terminal device 110-1, a second terminal device 110-2 and a network device 120, can communicate with each other. The first terminal device 110-1 and the second terminal device 110-2 are performing SL communication.

In the example of FIG. 1, the first terminal device 110-1 may be a UE, the second terminal device 110-2 may be a UE as well, and the network device 120 may be a base station serving one of or both of the UEs.

It is to be understood that the number of devices and their connections shown in FIG. 1 are only for the purpose of illustration without suggesting any limitation. The communication environment 100 may include any suitable number of devices configured to implementing example embodiments of the present disclosure. Although not shown, it would be appreciated that one or more additional devices may be located in a cell managed by the network device 120, and one or more additional cells may be deployed in the communication environment 100. It is noted that although illustrated as a network device, the network device 120 may be another device than a network device. Although illustrated as a terminal device, the terminal device 110-1 or 110-2 may be other suitable device than a terminal device.

In the following, for the purpose of illustration, some example embodiments are described with the first terminal device 110-1 or the second terminal device 110-2 operating as a UE and the network device 120 operating as a base station. However, in some example embodiments, operations described in connection with a terminal device may be implemented at a network device or other device, and operations described in connection with a network device may be implemented at a terminal device or other device.

In some example embodiments, if the first terminal device 110-1 or the second terminal device 110-2 is a terminal device and the network device 120 is a network device, a link from the network device 120 to the first terminal device 110-1 or the second terminal device 110-2 is referred to as a downlink (DL), while a link from the first terminal device 110-1 or the second terminal device 110-2 to the network device 120 is referred to as an uplink (UL). In DL, the network device 120 is a transmitting (TX) device (or a transmitter) and the first terminal device 110-1 or the second terminal device 110-2 is a receiving (RX) device (or a receiver). In UL, the first terminal device 110-1 or the second terminal device 110-2 is a TX device (or a transmitter) and the network device 120 is an RX device (or a receiver).

The communications in the communication environment 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In the following, although some operations are described from a perspective of the first terminal device 110-1, it is to be understood that the corresponding operations should be performed by the second terminal device 110-2 and/or the network device 120, and vice versa.

Reference is made to FIG. 2, which illustrates a signaling flow 200 of an SL communication configured with more than one frequency in accordance with some embodiments of the present disclosure. As used herein, the term “frequency” refers to a range of frequencies or a frequency point representing the range of frequencies. For instance, a frequency may refer to a carrier in some embodiments of the present disclosure.

For the purposes of discussion, the signaling flow 200 will be discussed with reference to FIG. 1, for example, by involving the first terminal device 110-1 and the second terminal device 110-2, as well as the network device 120. The signaling flow 300 involves the first terminal device 110-1 and the second terminal device 110-2 which are going to perform an SL communication (also referred to as “SL transmission” in embodiments of the present disclosure). The first terminal device 110-1 may be a Tx terminal device, and the second terminal device 110-2 may be an Rx terminal device. Alternatively, the first terminal device 110-1 may be an Rx terminal device, and the second terminal device 110-2 may be a Tx terminal device.

The first terminal device 110-1 determines (210), a set of resources on at least one frequency to be used for the SL transmission between the first terminal device 110-1 and the second terminal device 110-2. The first terminal device 110-1 is configured with more than one frequency, for example, one or more carriers. The SL transmission relates to several types of communication between the first terminal device 110-1 and the second terminal device 110-2. For instance, the SL transmission comprises a signal radio bear (SRB) transmission, a physical sidelink feedback channel (PSFCH) transmission, a medium access control (MAC) control element (CE) transmission, and/or the like. It is to be understood that the above example transmissions comprised in the SL transmission are just illustrated for purpose of discussion, without suggesting any limitation. Other suitable types of communication/transmission may be also applicable.

In some embodiments, the determination (210) of the set of resources may be implemented in various ways. For example, as shown with respect to FIG. 2, the first terminal device 110-1 may receive (211) a first configuration from the network device 120 and determines (210) the set of resources based on the first configuration.

The first configuration may be generated at the network device 120 to indicate a set of resources on at least one frequency to be used for the SL transmission between the first terminal device 110-1 and the second terminal device 110-2. In addition or alternatively, in some embodiments, the first configuration may indicate the at least one frequency (such as, one or more carriers) as well as a resource pool configuration corresponding to the at least one frequency. It is to be understood that the above examples indicated in the first configuration are just illustrated for discussion, rather than suggest any limitations. In other embodiments of the present disclosure, the network device 120 may provide other information to the first terminal device 110-1 by using the first configuration.

The network device 120 may transmit the first configuration to the first terminal device 110-1 in several ways. For example, the network device 120 may transmit the first configuration via a radio resource control (RRC) signalling, a system information block (SIB), and/or other suitable message. With the first configuration, the first terminal device 110-1 may determine (210) the set of resources based on thereon.

As an alternative to the above way for determining the set of resources, the first terminal device 110-1 may determine (212-1) first information, inform the network device 120 by transmitting a configuration (also referred to as “second configuration” for purpose of discussion) indicating first information (such as frequency-related information as discussed below), and determine the set of resources based on the first information and a further configuration (also referred to as “third configuration” for purpose of discussion) received from the network device 120.

The first information may be determined (212-1) via an upper layer of the first terminal device 110-1. The upper layer of the first terminal device 110-1 may be, for instance, a radio resource control (RRC) layer or a vehicle to everything (V2X) layer. The first information may indicate a set of frequencies comprising the at least one frequency, one or more mappings, and/or the like. As to the one or more mappings, each mapping may indicate a correspondence between a set of frequencies and a destination identity. For example, there may be a mapping for use by the SL transmission of an SRB. As another example, there may be a further mapping for use by PSFCH transmission.

The first terminal device 110-1 then transmit (212-2) a second configuration to the network device 120. The second configuration may indicate the first information, an indication indicating resources indicated by the first information are used for the SL transmission, and/or the like. The network device 120 may generate or determine a resources pool configuration (also referred as a “third configuration” for discussion) corresponding to the at least one frequency and transmit the third configuration to the first terminal device 110-1.

The resources pool configuration may indicate at least one set of resource pools, and each set of resource pools corresponds to each of the at least one frequency. In other words, one frequency may correspond to one or more resource pool, and the first terminal device 110-1 may select one resource pool to perform the communication with the second terminal device 110-2.

Alternatively or in addition, the resources pool configuration may indicate a channel busy ratio (CBR) threshold corresponding to a priority or a frequency (such as, a carrier) as well. In addition, or as a further alternative, the resources pool configuration may indicate a resource allocation mode (such as, resource allocation model, mode 2, mode 3 and mode 4), a resource allocation mechanism for a resource allocation mode, and/or the like.

In some embodiments, the resource allocation mode may refer to either a scheduled resource allocation or an autonomous resource selection. As one example, mode 1 may correspond to the scheduled resource allocation, and mode 2 may correspond to the autonomous resource selection.

In some embodiments, the resource allocation mechanism may be any of sensing or partial sensing or random selection. Additionally, information about resource allocation mechanism is needed only for a certain resource allocation mode. As one example, in case of mode 2, resource allocation mechanism is needed and example resource allocation mechanism may be one of the following: sensing or partial sensing or random selection.

It is to be understood that, the above illustrated resource allocation modes and resource allocation mechanisms are only for the purpose of illustration without suggesting any limitations. In other words, resource allocation modes and resource allocation mechanisms may be any currently-defined or resource allocation modes and resource allocation mechanisms, or may be any resource allocation modes and resource allocation mechanisms defined in the future. In present disclosure is not limited in this regard.

The first terminal device 110-1, upon receiving (212-2) the third configuration from the network device 120, may determine (210) the set of resources based on the second and third configurations.

The set of resources determined (210) by the first terminal device 110-1 in either way discussed above may be pre-configured semi-static resources, or dynamically-scheduled resources. For instance, the set of resources may comprise a plurality of resource elements on one or more carriers to be used for the SL transmission. With the knowledge of the set of resources, the first terminal device 110-1 performs (220) the SL transmission on the set of resources with the second terminal device 110-2.

Merely for a better understanding, some example embodiments for the above processes are discussed as below.

In some implementations of the present disclosure, for purpose of discussion, a terminal device may be also referred to as a UE, and the network device may be also referred to as a network(NW). During the SRB 0/1/2 transmission, peer UEs (for example the first terminal device 110-1 and the second terminal device 110-2) cannot know the carrier list configuration exactly. Therefore, the transmission reliability cannot be ensured by the negotiation of peer UEs. Instead, it should rely on network configuration to align the SRB0/1/2 transmission of Tx UE and reception of Rx UE.

In some embodiments, a UE may receive a configuration (i.e., the first configuration) from the network device which indicated the resource used for SL-SRB0/1/2 transmission. The configuration may include at least one of the following: a frequency list, which may include one or more frequency information item and/or a resource pool configuration.

The configuration may be transmitted in various ways. For example, the configuration may be sent through SIB, a dedicated RRC signalling, and/or the like.

In some embodiments, the UE may receive a configuration (i.e., the first information) from its upper layer which indicates the resource information used for SL-SRB0/1/2 transmission. This configuration may comprise a mapping(s) between a frequency list and an initial destination identification (ID) and/or a frequency list. After the UE reception of such configuration from its upper layer, the UE may report the mapping(s) between a frequency list and an initial destination ID and/or the frequency list towards the network and further indicate the usage is for SL-SRB0/1/2 transmission, if the UE is in the RRC_CONNECTED state.

Then, the UE may receive a further configuration (i.e., the third configuration) from the network, which indicates the resource pool configuration on one or more reported frequencies.

In some embodiments, the resource pool configuration may include a per priority CBR threshold configuration. Alternatively or in addition, the resource pool configuration may include a resource allocation mechanism for mode 2, for example, sensing or partial sensing or random selection. Alternatively or in addition, the resource pool configuration may include a resource allocation mode, for example, mode 1, mode 2 or the like.

In some embodiments, the network device may configure default resources for performing the transmission of SL-SRB0, SL-SRB1, or SL-SRB2, or may be a PSFCH transmission, an SL MAC CE transmission as discussed below.

In some embodiments, the UE may receive a configuration (i.e., the first configuration) from the network which indicates the resources used for SL-SRB0/1/2 transmission a PSFCH transmission, an SL MAC CE transmission. For instance, the configuration may include at least one of a default carrier which will be used for unicast related signalling transmission, or a resource pool configuration on the default carrier. There are several types of the unicast related signalling transmission. For example, the unicast related signalling transmission may be a transmission of SL-SRB0, SL-SRB1, or SL-SRB2, or may be a PSFCH transmission, an SL MAC CE transmission, or the like. Alternatively, more than one carrier may be configured as the default resources.

The UE may receive the configuration from the network through different ways. For example, the configuration may be sent through at least one of SIB or a dedicated RRC signalling from the network. After the UE's reception on the default carrier and corresponding resource pool configuration, it may perform transmission on the corresponding carrier.

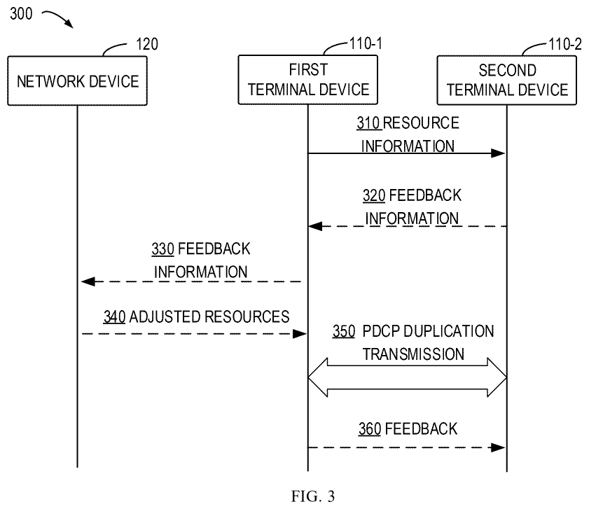

FIG. 3 illustrates a signaling flow 300 of a PDCP duplication communication in accordance with some embodiments of the present disclosure. For the purposes of discussion, the signaling flow 300 will be discussed with reference to FIG. 1, for example, by using the first terminal device 110-1, the second terminal device 110-2 and the network device 120.

The signaling flow 300 involves the network device 120, as well as the first terminal device 110-1 and the second terminal device 110-2 which are going to perform a PDCP duplication transmission. The first terminal device 110-1 may be a Tx terminal device or a transmitter device, and the second terminal device 110-2 may be an Rx terminal device or a receiver device. Alternatively, the first terminal device 110-1 may be an Rx terminal device or a receiver device, and the second terminal device 110-2 may be a Tx terminal device or a transmitter device.

As shown in FIG. 3, prior to performing the PDCP duplication transmission, the first terminal device 110-1 transmits (310) resource information to the second terminal device 110-2. The resource information indicates at least one of first resources, second resources, third resources, or a mapping of an original radio link control (RLC) channel and a duplicated RLC channel. Specifically, the first resources are used by the first terminal device for a PSFCH transmission. The second resources are used by the first terminal device to perform the PDCP duplication transmission. The third resources are resources on which the first terminal device expects to receive a PSFCH transmission.

In some embodiments, if the first terminal device 110-1 is a receiver device, the resource information may indicate the first resources. If the first terminal device 110-1 is a transmitter device, the resource information may indicate the second resources, the third resources and/or the mapping.

Alternatively, in some embodiments, if the second terminal device 110-2 is a transmitter device, the resource information may indicate the first resources. If the second terminal device 110-2 is a receiver device, the resource information may indicate at least one of the following the second resources, the third resources or the mapping.

The second terminal device 110-2 receives the resource information from the first terminal device 110-1. Thus, the second terminal device 110-2 may have the knowledge of the upcoming PDCP duplication transmission or the feedback resources for the upcoming PDCP duplication transmission. For example, with the resource information, the second terminal device 110-2 may know resources to be used for communication between the first terminal device 110-1 and the second terminal device 110-2. Furthermore, the second terminal device 110-2 may know the mapping between the original RLC channel and the duplicated RLC channel. In some embodiments, the mapping may be configured by the network device 120 or the first terminal device 110-1.

Then, the first terminal device 110-1 and the second terminal device 110-2 perform (350) the PDCP duplication transmission based at least in part on the resource information.

In some embodiments, the resource information may indicate the first resources in a variety of ways. For example, the first resources may be indicated by at least one reception resource pool of the first terminal device 110-1 corresponding to a frequency, by at least one resource pool used for transmitting a PSFCH transmission, at least one frequency used for transmitting the PSFCH transmission, by an indication indicating the PSFCH transmission is to be performed for each RLC channel, and/or the like.

The second terminal device 110-2 may transmit (320) feedback information on the resource configuration to the first terminal device 110-1. Then, the first terminal device 110-1 may transmit (330) the feedback information on the resource configuration to the network device 120, as shown in FIG. 3. Alternatively, in some embodiments, the second terminal device 110-2 may directly transmit the feedback information to the network device 120.

The feedback information may indicate whether the first resources are confirmed or rejected by the second terminal device, or whether the second resources are confirmed or rejected by the second terminal device. Alternatively, or in addition, the feedback information may indicate third resources comprised in the first resources that are confirmed or rejected by the second terminal device, or fourth resources comprised in the second resources that are confirmed or rejected by the second terminal device. It is to be understood that the above examples indicated by the feedback information are just discussed for illustration, rather than suggesting any limitations. Other information can be also comprised in the feedback information.

The network device 120 receives the feedback information from the first terminal device 110-1. Additionally, in some embodiments, the network device 120 may further adjust the first resources and/or the second resources, which for example may be indicated by the feedback information. For example, if either the first resources or the second resources, or both are rejected by the second terminal device, the network device 120 may adjust the first resources and/or the second resources and inform the first terminal device 110-1 the adjustment by transmitting a message. The first terminal device 110-1 may receive (340), from the network device 120, the message indicating at least one of the adjusted first resources or adjusted second resources, and thus will know the corresponding adjustment.

During performing (350) the PDCP duplication transmission, the first terminal device 110-1 may receive the PDCP duplication transmission from the second terminal device 110-2, for example, via a first radio link control (RLC) channel and a second RLC channel. In response, the first terminal device 110-1 may transmit (360) a PSFCH transmission of the PDCP duplication transmission to the second terminal device.

The PSFCH transmission may indicate at least one of the following: a negative acknowledgement (NACK) for a PDCP packet if the PDCP packet is failed on both the first and second RLC channel, an RLC channel of the first and second RLC channel on which the PDCP packet is failed, an acknowledgement (ACK) for a PDCP packet if the PDCP packet is successful on either the first or second RLC channel, an ACK for a PDCP packet if the PDCP packet is successful on both the first and second RLC channel, or an RLC channel of the first and second RLC channel on which the PDCP packet is successful. It is to be understood that the above examples indicated by the PSFCH transmission are just discussed for illustration, rather than suggesting any limitations. Other information can be also indicated by the PSFCH transmission.

Merely for a better understanding, some example embodiments for the above processes are discussed as below.

In the following example implementations of the present disclosure, for purpose of discussion, a terminal device may be also referred to as a UE, and the network device may be also referred to as NW or network. More specifically, the first terminal device 110-1 may be also referred to as UE1, the second terminal device 110-2 may be also referred to as UE2 or a peer UE of UE1.

For PDCP duplication in unicast, after UE1 receives the reception configuration from the network device (alternatively, UE1 may be pre-configuration and thus such reception may be omitted), if it has set up the PC5-RRC connection/is setting up the PC5-RRC connection with the peer UE (UE2), UE1 may transmit its reception resource pool configurations on each carrier towards peer UE. Alternatively, UE1 may transmit the reception resource pool configuration on one carrier where it will use for PSFCH transmission towards peer UE. Alternatively, UE1 may transmit the carrier(s) on which it will perform PSFCH transmissions. As a further alternative, UE1 may indicate that it will perform PSFCH transmission on every carrier.

After peer UE's reception on the PSFCH transmission configuration from UE1, it will confirm/reject the configuration via, for example, PC5-RRC signalling, SL-MAC CE, sidelink control information (SCI), and so on.

After peer UE's confirmation on the PSFCH transmission configuration from UE1, it will report the configuration towards its network if it is in RRC_CONNECTED state. In details, if UE1 decides to transmit PSFCH on the resource pool of one specific carrier for PDCP duplication reception, it may indicate at least the following info via PSFCH resource: UE1 will indicate a NACK if it does not receive any packet on either carrier for nack-only feedback, UE1 will indicate a NACK for specific RLC channel (original LCID/duplicated LCID indication) if it does not receive any packet on that RLC channel for nack-only/ack-nack feedback, UE1 will indicate an ACK if it receive one packet from either carrier for ack-nack feedback, UE1 will indicate an ACK for specific RLC channel if it receive packet on both RLC channels for ack-nack feedback, and/or the like.

After UE1 receives the confirm/reject indication from its peer UE, it will report the result towards the network device, for example, network device 120, if it is in RRC CONNECTED state.

The PSFCH transmission of either UE1 or UE2 is dynamic. For example, to ensure the resource usage efficiency and transmission reliability, the transmitter UE or Tx UE may indicate its preferred carrier for the PSFCH reception, for example, by using SCI, PC5-RRC signalling, SL MAC CE.

In some implementations, when UE1 perform PDCP duplication transmission towards peer UE, it may use the LCID for original transmission and duplicated transmission by a hard coded mapping between original LCID and duplicated LCID; or, a mapping configuration via network between original LCID and duplicated LCID if the UE is in RRC_CONNECTED State, for which the configuration should be transmitted towards the peer UE; or, a mapping configuration decided by itself between original LCID and duplicated LCID, for which the configuration should be transmitted towards the peer UE.

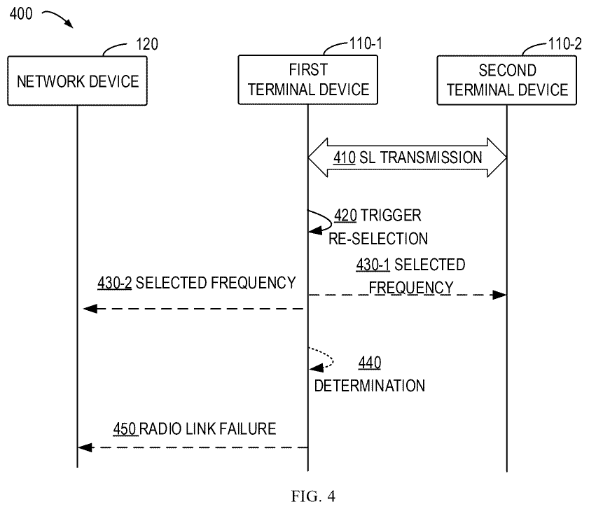

FIG. 4 illustrates a signaling flow 400 of a reselection procedure for SL communication in accordance with some embodiments of the present disclosure. For the purposes of discussion, the signaling flow 400 will be discussed with reference to FIG. 1, for example, by using the first terminal device 110-1, the second terminal device 110-2 and the network device 120.

Similar to the signaling flow 200, the signaling flow 400 involves the network device 120, as well as the first terminal device 110-1 and the second terminal device 110-2 which perform an SL transmission. The first terminal device 110-1 may be a Tx terminal device or a transmitter device, and the second terminal device 110-2 may be an Rx terminal device or a receiver device. Alternatively, the first terminal device 110-1 may be an Rx terminal device or a receiver device, and the second terminal device 110-2 may be a Tx terminal device or a transmitter device.

As shown in FIG. 4, the first terminal device 110-1 performs (410) an SL transmission on a plurality of frequencies with a second terminal device 110-2. In case of some condition(s) are met, the first terminal device 110-1 triggers (420) a selection (may be a selection for the first time or a reselection) of a frequency of the plurality of frequencies.

For example, if the number of negative acknowledgement (NACK) associated with the frequency is larger than or equal to a first threshold number, the first terminal device 110-1 triggers (420) the selection. In another example, if a first channel busy ratio (CBR) value associated with the frequency measured by the first terminal device is larger than or equal to a first threshold value, the first terminal device 110-1 triggers (420) the selection. In a further example, if a second CBR value associated with the frequency measured by the second terminal device is larger than or equal to a second threshold value, the first terminal device 110-1 triggers (420) the selection. It is to be understood that the above example conditions are illustrated for discussion rather than suggest any limitations. There may other suitable conditions for triggering the selection/reselection.

In some embodiments, in response to a success of the selection, the first terminal device 110-1 may transmit (430-1) a message indicating at least the selected frequency to the second terminal device 110-2. Alternatively or in addition, the first terminal device 110-1 may transmit (430-2) such message to indicate the selected frequency to the network device 120.

Additionally, or alternatively, in some embodiments, the first terminal device 110-1 may count the number of frequencies unavailable for the SL transmission. If the first terminal device 110-1 determines (440) that the number of frequencies unavailable for the SL transmission is larger than or equal to a second threshold number, it may report (450) a radio link failure to the network device 120.

Merely for a better understanding, some example embodiments for the above processes are discussed as below.

In the following example implementations of the present disclosure, for purpose of discussion, a terminal device may be also referred to as a UE, and the network device may be also referred to as NW or network. More specifically, the first terminal device 110-1 may be also referred to as UE.

When the first terminal device 110-1 performs PSFCH feedback as NACK-only/ACK-NACK per each carrier, the first terminal device 110-1 may maintain a counter for each carrier to count the number of consecutive nack for each carrier. Meanwhile, the first terminal device 110-1 may be configured with a NACK counter threshold by the network device 120. For example, the counter threshold may be configured per carrier, per UE, or by other suitable granularity(ies).

If the number of NACK count on the specific carrier is larger than or equal to the configured counter threshold, the first terminal device 110-1 may be triggered to perform resource reselection (or selection) on that resource (e.g., carrier). If resource reselection triggered on all configured carriers, then the first terminal device 110-1 may trigger radio link failure (RLF).

The first terminal device 110-1 may report the CBR measurement on the configured resource pool on each carrier, and report the CBR measurement results towards the peer UE, for example, the second terminal device 110-2. If the CBR measurement of the second terminal device 110-2 (i.e., peer UE) is above the configured threshold on the specific carrier, the first terminal device 110-1 will trigger resource reselection on the specific carrier.

Once the first terminal device 110-1 performs carrier reselection due to the trigger of resource reselection, it may report the reselected carrier set towards the second terminal device 110-2 (i.e., peer UE) via PC5-RRC message.

Once the second terminal device 110-2 performs carrier reselection due to the trigger of resource reselection, it may report the selected/reselected carrier set towards the network device 120 via a RRC message if the first terminal device 110-1 is in RRC CONNECTED state.

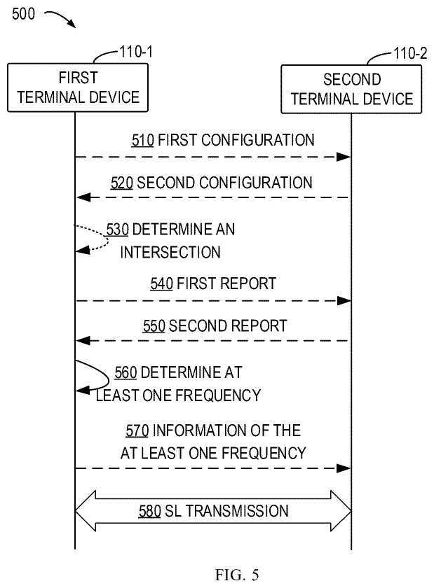

FIG. 5 illustrates a signaling flow 500 of a frequency selection procedure for an SL communication in accordance with some embodiments of the present disclosure. For the purposes of discussion, the signaling flow 500 will be discussed with reference to FIG. 1, for example, by using the first terminal device 110-1 and the second terminal device 110-2.

The signaling flow 500 involves the first terminal device 110-1 and the second terminal device 110-2 which perform an SL transmission. The first terminal device 110-1 may be a Tx terminal device or a transmitter device, and the second terminal device 110-2 may be an Rx terminal device or a receiver device. Alternatively, the first terminal device 110-1 may be an Rx terminal device or a receiver device, and the second terminal device 110-2 may be a Tx terminal device or a transmitter device.

As shown in FIG. 5, the first terminal device 110-1 determines (560) at least one frequency to be used by the first terminal device 110-1 for a sidelink (SL) transmission with the second terminal device 110-2. The determination (560) is based on at least one of the following: a first set of frequencies supported by the first terminal device, a second set of frequencies supported by the second terminal device, a first set of channel busy ratio (CBR) measurement results associated with at least part of the first set of frequencies, a second set of CBR measurement results associated with at least part of the second set of frequencies, and/or other related factors. Then the first terminal device 110-1 performs (580) the SL communication on the at least one frequency with the second terminal device 110-2.

Optionally, in some embodiments, the first terminal device 110-1 may transmit (570) information indicating the at least one frequency to the second terminal device 110-2 or the network device 120.

Additionally, in some embodiments, the first terminal device 110-1 may transmit (510) a first configuration indicating the first set of frequencies to the second terminal device 110-2. In addition, the first terminal device 110-1 may receive (520) a second configuration indicating the second set of frequencies from the second terminal device 110-2. With both of the first set of frequencies and the second set of frequencies, the first terminal device 110-1 may determine (530) an intersection set of the first set of frequencies and the second set of frequencies. Both the first set of CBR measurement results and the second set of CBR measurement results are associated with the intersection set.

Optionally, the first terminal device 110-1 may transmit (540) a first report indicating the first set of CBR measurement results to the second terminal device 110-2. In some embodiments, the first terminal device 110-1 may receive (550) a second report indicating the second set of CBR measurement results from the second terminal device 110-2. It is to be understood that the receiving (550) operation may be performed before, simultaneously or after the transmitting (540) operation.

Merely for a better understanding, some example embodiments for the above processes are discussed as below.

In the following example implementations of the present disclosure, for purpose of discussion, a terminal device may be also referred to as a UE, and the network device may be also referred to as NW or network. More specifically, the first terminal device 110-1 may be also referred to as UE-A, and the second terminal device 110-2 may be also referred to as UE-B.

In a carrier selection procedure, the UE-A shall be configured with a service to carrier list—A mapping relationship, its peer UE-B shall be configured with a service to carrier list—B mapping relationship.

When UE-A performs carrier selection, peer UE-B should report the service to carrier list-B mapping relationship towards UE-A, UE-A should perform carrier selection within the intersectional set of carrier set-A and carrier set-B, which is carrier set-C.

In details, UE-A may first take CBR measurement on each carrier of carrier set-C, meanwhile, UE-A will receive the CBR measurement result of each carrier in carrier set-C from UE-B, UE-A will filter out those carrier into the candidate selected carrier list within carrier set-C which fulfills the following condition: the CBR measurement of both UE-A and UE-B on the resource pool of specific carrier are below a configured threshold.

UE-A may select the carrier from its lowest CBR measurement order from the candidate selected carrier list.

For each unicast link, UE-A may report the selected carrier list towards the network device 120 with the associated destination layer 2 ID, if the UE-A is in RRC CONNECTED state.

UE-A may report the selected carrier list towards peer UE-B via PC5-RRC message, once the peer UE-B receiving the selected carrier list, it should report the selected carrier list of UE-B towards its network device 120.

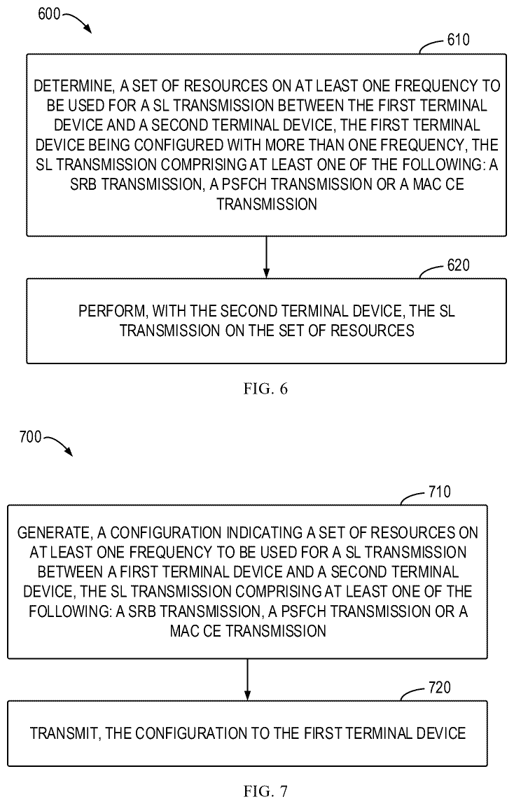

FIG. 6 illustrates a flowchart of a communication method 600 implemented at a first terminal device in accordance with some embodiments of the present disclosure. For the purpose of discussion, the method 600 will be described from the perspective of the first terminal device 110-1 in FIG. 1.

At block 610, the first terminal device 110-1 determines a set of resources on at least one frequency to be used for a sidelink (SL) transmission between the first terminal device and a second terminal device, the first terminal device being configured with more than one frequency, the SL transmission comprising at least one of the following: a signal radio bear (SRB) transmission, a physical sidelink feedback channel (PSFCH) transmission or a medium access control (MAC) control element (CE) transmission.

At block 620, the first terminal device 110-1 performs, with the second terminal device, the SL transmission on the set of resources.

In some example embodiments, the first terminal device 110-1 receives a first configuration from a network device, the first configuration indicating the following: the at least one frequency, or a resource pool configuration corresponding to the at least one frequency; and determining the set of resources based on the first configuration.

In some example embodiments, the first configuration is transmitted via at least one of the following: a radio resource control (RRC) signalling, or system information block (SIB).

In some example embodiments, the first terminal device 110-1 may determine, via an upper layer of the first terminal device, first information indicating at least one of the following: a set of frequencies comprising the at least one frequency, or at least one mapping, each mapping indicating a correspondence between a set of frequencies and a destination identity.

In some example embodiments, the first terminal device 110-1 may transmit a second configuration to a network device, the second configuration indicating at least one of the following: the first information, an indication indicating resources indicated by the first information are used for the SL transmission; receive, from the network device, a third configuration indicating a resources pool configuration corresponding to the at least one frequency; and determine the set of resources based on the second and third configurations.

In some example embodiments, the upper layer of the first terminal device is a radio resource control (RRC) layer or a vehicle to everything (V2X) layer.

In some example embodiments, the resources pool configuration indicates at least one of the following: at least one set of resource pools, each set of resource pools corresponding to each of the at least one frequency, a channel busy ratio (CBR) threshold corresponding to a priority or a frequency, a resource allocation mode, or a resource allocation mechanism for a resource allocation mode.

In some example embodiments, the set of resources are pre-configured semi-static resources, or dynamically-scheduled resources.

In some example embodiments, one of the first and second terminal device is a transmitter device and the other one of the first and second terminal device is a receiver device.

FIG. 7 illustrates a flowchart of a communication method 700 implemented at a network device in accordance with some embodiments of the present disclosure. For the purpose of discussion, the method 700 will be described from the perspective of network device 120 in FIG. 1.

At block 710, the network device 120 generates a configuration indicating a set of resources on at least one frequency to be used for a sidelink (SL) transmission between a first terminal device and a second terminal device, the SL transmission comprising at least one of the following: a signal radio bear (SRB) transmission, a physical sidelink feedback channel (PSFCH) transmission or a medium access control (MAC) control element (CE) transmission.

At block 720, the network device 120 transmits the configuration to the first terminal device.

In some example embodiments, the network device 120 may, prior to transmitting the configuration to the first terminal device, receive, a second configuration from the first terminal device, the second configuration indicating at least one of the following: a set of frequencies comprising the at least one frequency, at least one mapping, each mapping indicating a correspondence between a set of frequencies and a destination identity, an indication indicating the set of frequencies are used for the SL transmission.

In some example embodiments, the configuration indicates at least one of the following: the at least one frequency, or a resource pool configuration corresponding to the at least one frequency.

In some example embodiments, the resources pool configuration indicates at least one of the following: at least one set of resource pools, each set of resource pools corresponding to each of the at least one frequency, a channel busy ratio (CBR) threshold corresponding to a priority or a frequency, a resource allocation mode, or a resource allocation mechanism for a specific resource allocation mode.

In some example embodiments, the configuration is transmitted via at least one of the following: a radio resource control (RRC) signalling, or system information block (SIB).

In some example embodiments, the set of resources are pre-configured semi-static resources, or dynamically-scheduled resources.

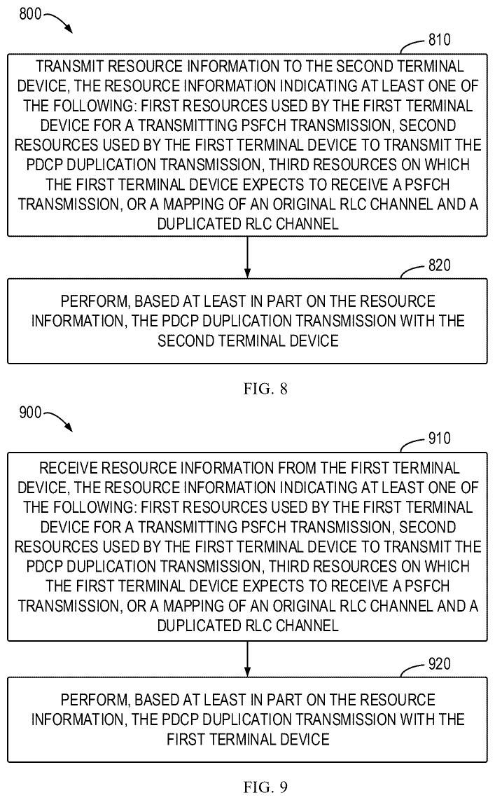

FIG. 8 illustrates a flowchart of a communication method 800 implemented at a first terminal device in accordance with some embodiments of the present disclosure. For the purpose of discussion, the method 800 will be described from the perspective of the first terminal device 110-1 in FIG. 1.

At block 810, the first terminal device 110-1, prior to performing a packet data convergence protocol (PDCP) duplication transmission with a second terminal device, transmits resource information to the second terminal device, the resource information indicating at least one of the following: first resources used by the first terminal device for a physical sidelink feedback channel (PSFCH) transmission, second resources used by the first terminal device to perform the PDCP duplication transmission, third resources on which the first terminal device expects to receive a PSFCH transmission, or a mapping of an original radio link control (RLC) channel and a duplicated RLC channel.

At block 820, the first terminal device 110-1 performs, based at least in part on the resource information, the PDCP duplication transmission with the second terminal device.

In some example embodiments, the resource information indicates the first resources by at least one of the following: at least one reception resource pool of the first terminal device corresponding to a frequency, at least one resource pool used for transmitting a physical sidelink feedback channel (PSFCH) transmission, at least one frequency used for transmitting the PSFCH transmission, an indication indicating the PSFCH transmission is to be performed for each radio link control (RLC) channel.

In some example embodiments, the mapping is configured by a network device or the first terminal device.

In some example embodiments, the first terminal device 110-1 may receive feedback information from the second terminal device, the feedback information indicating at least one of the following: whether the first resources are confirmed or rejected by the second terminal device, whether the second resources are confirmed or rejected by the second terminal device, third resources comprised in the first resources that are confirmed or rejected by the second terminal device, or fourth resources comprised in the second resources that are confirmed or rejected by the second terminal device.

In some example embodiments, the first terminal device 110-1 may transmit the feedback information to a network device serving the first terminal device.

In some example embodiments, the first terminal device 110-1 may, if at least one of the first resources or the second resources is rejected by the second terminal device, receive, from the network device, a message indicating at least one of the adjusted first resources or adjusted second resources.

In some example embodiments, the first terminal device 110-1 may receive the PDCP duplication transmission from the second terminal device via a first radio link control (RLC) channel and a second RLC channel; and transmit a PSFCH transmission of the PDCP duplication transmission to the second terminal device, the PSFCH transmission indicating at least one of the following: a negative acknowledgement (NACK) for a PDCP packet if the PDCP packet is failed on both the first and second RLC channel, an RLC channel of the first and second RLC channel on which the PDCP packet is failed, an acknowledgement (ACK) for a PDCP packet if the PDCP packet is successful on either the first or second RLC channel, an ACK for a PDCP packet if the PDCP packet is successful on both the first and second RLC channel, or an RLC channel of the first and second RLC channel on which the PDCP packet is successful.

In some example embodiments, if the first terminal device 110-1 is a receiver device, the resource information indicates the first resources, and if the first terminal device 110-1 is a transmitter device, the resource information indicates at least one of the following: the second resources, the third resources or the mapping.

FIG. 9 illustrates a flowchart of a communication method 900 implemented at a second terminal device in accordance with some embodiments of the present disclosure. For the purpose of discussion, the method 900 will be described from the perspective of the second terminal device 110-2 in FIG. 1.

At block 910, the second terminal device 110-2, prior to performing a packet data convergence protocol (PDCP) duplication transmission with a first terminal device, receives resource information from the first terminal device, the resource information indicating at least one of the following: first resources used by the first terminal device for a transmitting physical sidelink feedback channel (PSFCH) transmission; or second resources used by the first terminal device to transmit the PDCP duplication transmission; third resources on which the first terminal device expects to receive a PSFCH transmission; or a mapping of an original radio link control (RLC) channel and a duplicated RLC channel.

At block 920, the second terminal device 110-2 performs, based at least in part on the resource information, the PDCP duplication transmission with the first terminal device 110-1.

In some example embodiments, the resource information indicates the first resources by at least one of the following: at least one reception resource pool of the first terminal device corresponding to a frequency, at least one resource pool used for transmitting a physical sidelink feedback channel (PSFCH) transmission, at least one frequency used for transmitting the PSFCH transmission, an indication indicating the PSFCH transmission is to be performed for each radio link control (RLC) channel.

In some example embodiments, the mapping is configured by a network device or the first terminal device.

In some example embodiments, the second terminal device 110-2 may transmit feedback information to the first terminal device or a network device serving the second terminal device, the feedback information indicating at least one of the following: whether the first resources are confirmed or rejected by the second terminal device, whether the second resources are confirmed or rejected by the second terminal device, third resources comprised in the first resources that are confirmed or rejected by the second terminal device, or fourth resources comprised in the second resources that are confirmed or rejected by the second terminal device.

In some example embodiments, the second terminal device 110-2 may transmit the PDCP duplication transmission to the first terminal device via a first radio link control (RLC) channel and a second RLC channel; and receive a PSFCH transmission for the PDCP duplication transmission to the second terminal device, the PSFCH transmission indicating at least one of the following: a negative acknowledgement (NACK) for a PDCP packet if the PDCP packet is failed on both the first and second RLC channel, an RLC channel of the first and second RLC channel on which the PDCP packet is failed, an acknowledgement (ACK) for a PDCP packet if the PDCP packet is successful on either the first or second RLC channel, an ACK for a PDCP packet if the PDCP packet is successful on both the first and second RLC channel, or an RLC channel of the first and second RLC channel on which the PDCP packet is successful.

In some example embodiments, if the second terminal device is a transmitter device, the resource information indicates the first resources, and if the second terminal device is a receiver device, the resource information indicates at least one of the following the second resources, the third resources or the mapping.

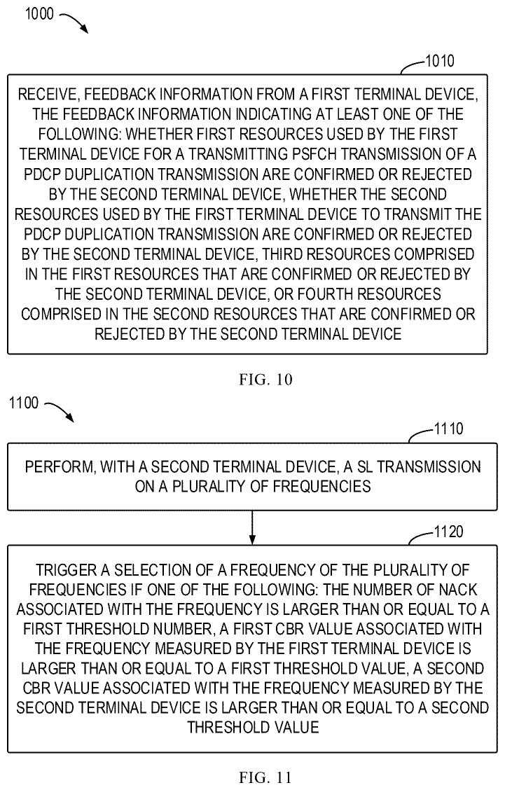

FIG. 10 illustrates a flowchart of a communication method 1000 implemented at a network device in accordance with some embodiments of the present disclosure. For the purpose of discussion, the method 1000 will be described from the perspective of the network device 120 in FIG. 1.

At block 1010, the network device 120 receives feedback information from a first terminal device, the feedback information indicating at least one of the following: whether first resources used by the first terminal device for a transmitting physical sidelink feedback channel (PSFCH) transmission of a packet data convergence protocol (PDCP) duplication transmission are confirmed or rejected by the second terminal device, whether the second resources used by the first terminal device to transmit the PDCP duplication transmission are confirmed or rejected by the second terminal device, third resources comprised in the first resources that are confirmed or rejected by the second terminal device, or fourth resources comprised in the second resources that are confirmed or rejected by the second terminal device.

In some example embodiments, the network device 120 may, if at least one of the first resources or the second resources is rejected by the second terminal device, transmit, to a first terminal device 110-1, a message indicating at least one of the following adjusted first resources or adjusted second resources.

FIG. 11 illustrates a flowchart of a communication method 1100 implemented at a first terminal device in accordance with some embodiments of the present disclosure. For the purpose of discussion, the method 1100 will be described from the perspective of the first terminal device 110-1 in FIG. 1.

At block 1110, the first terminal device 110-1 performs, with a second terminal device, a sidelink (SL) transmission on a plurality of frequencies.

At block 1120, the first terminal device 110-1 triggers a selection of a frequency of the plurality of frequencies if one of the following: the number of negative acknowledgement (NACK) associated with the frequency is larger than or equal to a first threshold number, a first channel busy ratio (CBR) value associated with the frequency measured by the first terminal device is larger than or equal to a first threshold value, a second CBR value associated with the frequency measured by the second terminal device is larger than or equal to a second threshold value.

In some example embodiments, the first terminal device 110-1 may, in response to a success of the re-selection, transmit a message indicating at least the re-selected frequency to the second terminal device or a network device.

In some example embodiments, the first terminal device 110-1 may, in accordance with a determination that the number of frequencies unavailable for the SL transmission is larger than or equal to a second threshold number, report a radio link failure to a network device.

In some example embodiments, one of the first and second terminal device is a transmitter device and the other one of the first and second terminal device is a receiver device.

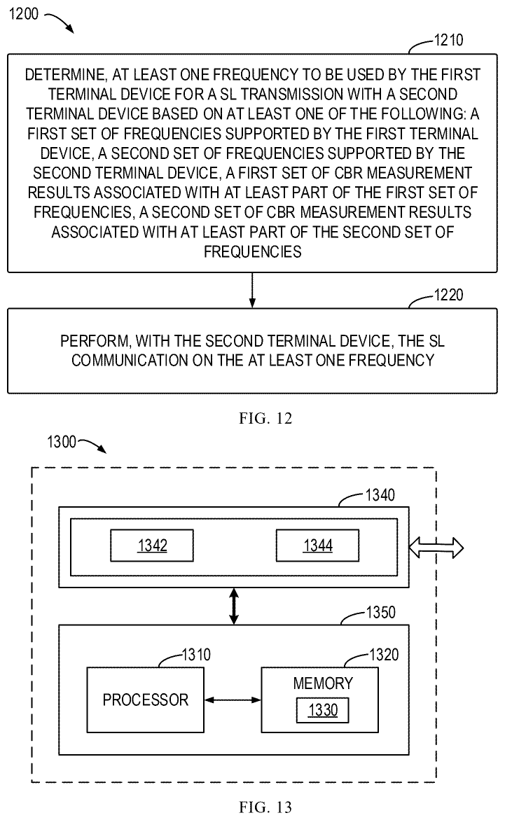

FIG. 12 illustrates a flowchart of a communication method 1200 implemented at a first terminal device in accordance with some embodiments of the present disclosure. For the purpose of discussion, the method 1200 will be described from the perspective of the first terminal device 110-1 in FIG. 1.

At block 1210, the first terminal device 110-1 determines at least one frequency to be used by the first terminal device for a sidelink (SL) transmission with a second terminal device based on at least one of the following: a first set of frequencies supported by the first terminal device, a second set of frequencies supported by the second terminal device, a first set of channel busy ratio (CBR) measurement results associated with at least part of the first set of frequencies, or a second set of CBR measurement results associated with at least part of the second set of frequencies.

At block 1260, the first terminal device 110-1 performs, with the second terminal device 110-2, the SL communication on the at least one frequency.

In some example embodiments, the first terminal device 110-1 may transmit a first configuration indicating the first set of frequencies to the second terminal device; receive a second configuration indicating the second set of frequencies from the second terminal device; and determine an intersection set of first and second sets of frequencies, and wherein the first and second sets of CBR measurement results are associated with the intersection set.

In some example embodiments, the first terminal device 110-1 may transmit a first report indicating the first set of CBR measurement results to the second terminal device; and receive a second report indicating the second set of CBR measurement results from the second terminal device.

In some example embodiments, the first terminal device 110-1 may transmit information indicating the at least one frequency to the second terminal device or a network device.

In some example embodiments, one of the first and second terminal device is a transmitter device and the other one of the first and second terminal device is a receiver device.

FIG. 13 is a simplified block diagram of a device 1300 that is suitable for implementing embodiments of the present disclosure. The device 1300 can be considered as a further example implementation of any of the devices as shown in FIG. 1. Accordingly, the device 1300 can be implemented at or as at least a part of the first terminal device 110-1, the second terminal device 110-2 or the network device 120.

As shown, the device 1300 includes a processor 1310, a memory 1320 coupled to the processor 1310, a suitable transceiver 1340 coupled to the processor 1310, and a communication interface coupled to the transceiver 1340. The memory 1310 stores at least a part of a program 1330. The transceiver 1340 may be for bidirectional communications or a unidirectional communication based on requirements. The transceiver 1340 may include at least one of a transmitter 1342 and a receiver 1344. The transmitter 1342 and the receiver 1344 may be functional modules or physical entities. The transceiver 1340 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1330 is assumed to include program instructions that, when executed by the associated processor 1310, enable the device 1300 to operate in accordance with the embodiments of the present disclosure, as discussed herein with reference to FIGS. 1 to 13. The embodiments herein may be implemented by computer software executable by the processor 1310 of the device 1300, or by hardware, or by a combination of software and hardware. The processor 1310 may be configured to implement various embodiments of the present disclosure. Furthermore, a combination of the processor 1310 and memory 1320 may form processing means 1350 adapted to implement various embodiments of the present disclosure.

The memory 1320 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1320 is shown in the device 1300, there may be several physically distinct memory modules in the device 1300. The processor 1310 may be of any type suitable to the local technical network, and may include one or more of general purpose computers, special purpose computers, microprocessors, digital signal processors (DSPs) and processors based on multicore processor architecture, as non-limiting examples. The device 1300 may have multiple processors, such as an application specific integrated circuit chip that is slaved in time to a clock which synchronizes the main processor.

According to embodiments of the present disclosure, a first terminal device comprising a circuitry is provided. The circuitry is configured to: determine a set of resources on at least one frequency to be used for a sidelink (SL) transmission between the first terminal device and a second terminal device, the first terminal device being configured with more than one frequency, the SL transmission comprising at least one of the following: a signal radio bear (SRB) transmission, a physical sidelink feedback channel (PSFCH) transmission or a medium access control (MAC) control element (CE) transmission; and perform, with the second terminal device, the SL transmission on the set of resources. According to embodiments of the present disclosure, the circuitry may be configured to perform any method implemented by the first terminal device as discussed above.

According to embodiments of the present disclosure, a network device comprising a circuitry is provided. The circuitry is configured to: generate a configuration indicating a set of resources on at least one frequency to be used for a sidelink (SL) transmission between a first terminal device and a second terminal device, the SL transmission comprising at least one of the following: a signal radio bear (SRB) transmission, a physical sidelink feedback channel (PSFCH) transmission or a medium access control (MAC) control element (CE) transmission; and transmit, the configuration to the first terminal device. According to embodiments of the present disclosure, the circuitry may be configured to perform any method implemented by the network device as discussed above.

According to embodiments of the present disclosure, a first terminal device comprising a circuitry is provided. The circuitry is configured to: prior to performing a packet data convergence protocol (PDCP) duplication transmission with a second terminal device, transmit resource information to the second terminal device, the resource information indicating at least one of the following first resources used by the first terminal device for a physical sidelink feedback channel (PSFCH) transmission, second resources used by the first terminal device to perform the PDCP duplication transmission, third resources on which the first terminal device expects to receive a PSFCH transmission, or a mapping of an original radio link control (RLC) channel and a duplicated RLC channel; perform, based at least in part on the resource information, the PDCP duplication transmission with the second terminal device. According to embodiments of the present disclosure, the circuitry may be configured to perform any method implemented by the first terminal device as discussed above.

According to embodiments of the present disclosure, a second terminal device comprising a circuitry is provided. The circuitry is configured to: prior to performing a packet data convergence protocol (PDCP) duplication transmission with a first terminal device, receive resource information from the first terminal device, the resource information indicating at least one of the following: first resources used by the first terminal device for a transmitting physical sidelink feedback channel (PSFCH) transmission; or second resources used by the first terminal device to transmit the PDCP duplication transmission; third resources on which the first terminal device expects to receive a PSFCH transmission; or a mapping of an original radio link control (RLC) channel and a duplicated RLC channel; and perform, based at least in part on the resource information, the PDCP duplication transmission with the first terminal device. According to embodiments of the present disclosure, the circuitry may be configured to perform any method implemented by the second terminal device as discussed above.

According to embodiments of the present disclosure, a network device comprising a circuitry is provided. The circuitry is configured to: receive feedback information from a first terminal device, the feedback information indicating at least one of the following: whether first resources used by the first terminal device for a transmitting physical sidelink feedback channel (PSFCH) transmission of a packet data convergence protocol (PDCP) duplication transmission are confirmed or rejected by the second terminal device, whether the second resources used by the first terminal device to transmit the PDCP duplication transmission are confirmed or rejected by the second terminal device, third resources comprised in the first resources that are confirmed or rejected by the second terminal device, or fourth resources comprised in the second resources that are confirmed or rejected by the second terminal device. According to embodiments of the present disclosure, the circuitry may be configured to perform any method implemented by the network device as discussed above.

According to embodiments of the present disclosure, a first terminal device comprising a circuitry is provided. The circuitry is configured to: perform, with a second terminal device, a sidelink (SL) transmission on a plurality of frequencies; and trigger a selection of a frequency of the plurality of frequencies if one of the following: the number of negative acknowledgement (NACK) associated with the frequency is larger than or equal to a first threshold number, a first channel busy ratio (CBR) value associated with the frequency measured by the first terminal device is larger than or equal to a first threshold value, a second CBR value associated with the frequency measured by the second terminal device is larger than or equal to a second threshold value. According to embodiments of the present disclosure, the circuitry may be configured to perform any method implemented by the first terminal device as discussed above.

According to embodiments of the present disclosure, a first terminal device comprising a circuitry is provided. The circuitry is configured to: determine at least one frequency to be used by the first terminal device for a sidelink (SL) transmission with a second terminal device based on at least one of the following: a first set of frequencies supported by the first terminal device, a second set of frequencies supported by the second terminal device, a first set of channel busy ratio (CBR) measurement results associated with at least part of the first set of frequencies, or a second set of CBR measurement results associated with at least part of the second set of frequencies; and perform, with the second terminal device, the SL communication on the at least one frequency. According to embodiments of the present disclosure, the circuitry may be configured to perform any method implemented by the first terminal device as discussed above.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following aspects.

In an aspect, it is proposed a first terminal device comprising: a processor configured to cause the first terminal device to: determine a set of resources on at least one frequency to be used for a sidelink (SL) transmission between the first terminal device and a second terminal device, the first terminal device being configured with more than one frequency, the SL transmission comprising at least one of the following: a signal radio bear (SRB) transmission, a physical sidelink feedback channel (PSFCH) transmission or a medium access control (MAC) control element (CE) transmission; and perform, with the second terminal device, the SL transmission on the set of resources.

In some embodiments, the processor is further configured to cause the first terminal device to: receive a first configuration from a network device, the first configuration indicating the following: the at least one frequency, or a resource pool configuration corresponding to the at least one frequency; and determining the set of resources based on the first configuration.

In some embodiments, the first configuration is transmitted via at least one of the following: a radio resource control (RRC) signalling, or system information block (SIB).

In some embodiments, the processor is further configured to cause the first terminal device to: determine, via an upper layer of the first terminal device, first information indicating at least one of the following: a set of frequencies comprising the at least one frequency, or at least one mapping, each mapping indicating a correspondence between a set of frequencies and a destination identity.

In some embodiments, the processor is further configured to cause the first terminal device to: transmit a second configuration to a network device, the second configuration indicating at least one of the following: the first information, an indication indicating resources indicated by the first information are used for the SL transmission; receive, from the network device, a third configuration indicating a resources pool configuration corresponding to the at least one frequency; and determine the set of resources based on the second and third configurations.

In some embodiments, the upper layer of the first terminal device is a radio resource control (RRC) layer or a vehicle to everything (V2X) layer.

In some embodiments, the resources pool configuration indicates at least one of the following: at least one set of resource pools, each set of resource pools corresponding to each of the at least one frequency, a channel busy ratio (CBR) threshold corresponding to a priority or a frequency, a resource allocation mode, or a resource allocation mechanism for a resource allocation mode.

In some embodiments, the set of resources are pre-configured semi-static resources, or dynamically-scheduled resources.

In some embodiments, one of the first and second terminal device is a transmitter device and the other one of the first and second terminal device is a receiver device.

In an aspect, it is proposed a network device comprising: a processor configured to cause the network device to: generate a configuration indicating a set of resources on at least one frequency to be used for a sidelink (SL) transmission between a first terminal device and a second terminal device, the SL transmission comprising at least one of the following: a signal radio bear (SRB) transmission, a physical sidelink feedback channel (PSFCH) transmission or a medium access control (MAC) control element (CE) transmission; and transmit, the configuration to the first terminal device.

In some embodiments, the processor is further configured to cause the network device to: prior to transmitting the configuration to the first terminal device, receive, a second configuration from the first terminal device, the second configuration indicating at least one of the following: a set of frequencies comprising the at least one frequency, at least one mapping, each mapping indicating a correspondence between a set of frequencies and a destination identity, an indication indicating the set of frequencies are used for the SL transmission.

In some embodiments, the configuration indicates at least one of the following: the at least one frequency, or a resource pool configuration corresponding to the at least one frequency.

In some embodiments, the resources pool configuration indicates at least one of the following: at least one set of resource pools, each set of resource pools corresponding to each of the at least one frequency, a channel busy ratio (CBR) threshold corresponding to a priority or a frequency, a resource allocation mode, or a resource allocation mechanism for a specific resource allocation mode.

In some embodiments, the configuration is transmitted via at least one of the following: a radio resource control (RRC) signalling, or system information block (SIB).

In some embodiments, the set of resources are pre-configured semi-static resources, or dynamically-scheduled resources.

In an aspect, it is proposed a first terminal device comprising: a processor configured to cause the first terminal device to: prior to performing a packet data convergence protocol (PDCP) duplication transmission with a second terminal device, transmit resource information to the second terminal device, the resource information indicating at least one of the following first resources used by the first terminal device for a physical sidelink feedback channel (PSFCH) transmission, second resources used by the first terminal device to perform the PDCP duplication transmission, third resources on which the first terminal device expects to receive a PSFCH transmission, or a mapping of an original radio link control (RLC) channel and a duplicated RLC channel; perform, based at least in part on the resource information, the PDCP duplication transmission with the second terminal device.

In some embodiments, the resource information indicates the first resources by at least one of the following: at least one reception resource pool of the first terminal device corresponding to a frequency, at least one resource pool used for transmitting a physical sidelink feedback channel (PSFCH) transmission, at least one frequency used for transmitting the PSFCH transmission, an indication indicating the PSFCH transmission is to be performed for each radio link control (RLC) channel.

In some embodiments, the mapping is configured by a network device or the first terminal device.

In some embodiments, the processor is further configured to cause first terminal device to: receive feedback information from the second terminal device, the feedback information indicating at least one of the following: whether the first resources are confirmed or rejected by the second terminal device, whether the second resources are confirmed or rejected by the second terminal device, third resources comprised in the first resources that are confirmed or rejected by the second terminal device, or fourth resources comprised in the second resources that are confirmed or rejected by the second terminal device.

In some embodiments, the processor is further configured to cause first terminal device to: transmit the feedback information to a network device serving the first terminal device.

In some embodiments, the processor is further configured to cause first terminal device to: if at least one of the first resources or the second resources is rejected by the second terminal device, receive, from the network device, a message indicating at least one of the adjusted first resources or adjusted second resources.

In some embodiments, the processor is further configured to cause the first terminal device to: receive the PDCP duplication transmission from the second terminal device via a first radio link control (RLC) channel and a second RLC channel; and transmit a PSFCH transmission of the PDCP duplication transmission to the second terminal device, the PSFCH transmission indicating at least one of the following: a negative acknowledgement (NACK) for a PDCP packet if the PDCP packet is failed on both the first and second RLC channel, an RLC channel of the first and second RLC channel on which the PDCP packet is failed, an acknowledgement (ACK) for a PDCP packet if the PDCP packet is successful on either the first or second RLC channel, an ACK for a PDCP packet if the PDCP packet is successful on both the first and second RLC channel, or an RLC channel of the first and second RLC channel on which the PDCP packet is successful.

In some embodiments, if the first terminal device is a receiver device, the resource information indicates the first resources, and if the first terminal device is a transmitter device, the resource information indicates at least one of the following: the second resources, the third resources or the mapping.

In an aspect, it is proposed a second terminal device comprising: a processor configured to cause the second terminal device to: prior to performing a packet data convergence protocol (PDCP) duplication transmission with a first terminal device, receive resource information from the first terminal device, the resource information indicating at least one of the following: first resources used by the first terminal device for a transmitting physical sidelink feedback channel (PSFCH) transmission; or second resources used by the first terminal device to transmit the PDCP duplication transmission; third resources on which the first terminal device expects to receive a PSFCH transmission; or a mapping of an original radio link control (RLC) channel and a duplicated RLC channel; and perform, based at least in part on the resource information, the PDCP duplication transmission with the first terminal device.

In some embodiments, the resource information indicates the first resources by at least one of the following: at least one reception resource pool of the first terminal device corresponding to a frequency, at least one resource pool used for transmitting a physical sidelink feedback channel (PSFCH) transmission, at least one frequency used for transmitting the PSFCH transmission, an indication indicating the PSFCH transmission is to be performed for each radio link control (RLC) channel.

In some embodiments, the mapping is configured by a network device or the first terminal device.

In some embodiments, the processor is further configured to second first terminal device to: transmit feedback information to the first terminal device or a network device serving the second terminal device, the feedback information indicating at least one of the following: whether the first resources are confirmed or rejected by the second terminal device, whether the second resources are confirmed or rejected by the second terminal device, third resources comprised in the first resources that are confirmed or rejected by the second terminal device, or fourth resources comprised in the second resources that are confirmed or rejected by the second terminal device.

In some embodiments, and where the processor is further configured to cause second terminal device to: transmit the PDCP duplication transmission to the first terminal device via a first radio link control (RLC) channel and a second RLC channel; and receive a PSFCH transmission for the PDCP duplication transmission to the second terminal device, the PSFCH transmission indicating at least one of the following: a negative acknowledgement (NACK) for a PDCP packet if the PDCP packet is failed on both the first and second RLC channel, an RLC channel of the first and second RLC channel on which the PDCP packet is failed, an acknowledgement (ACK) for a PDCP packet if the PDCP packet is successful on either the first or second RLC channel, an ACK for a PDCP packet if the PDCP packet is successful on both the first and second RLC channel, or an RLC channel of the first and second RLC channel on which the PDCP packet is successful.

In some embodiments, if the second terminal device is a transmitter device, the resource information indicates the first resources, and if the second terminal device is a receiver device, the resource information indicates at least one of the following the second resources, the third resources or the mapping.

In an aspect, it is proposed a network device comprising: a processor configured to cause the network device to: receive feedback information from a first terminal device, the feedback information indicating at least one of the following: whether first resources used by the first terminal device for a transmitting physical sidelink feedback channel (PSFCH) transmission of a packet data convergence protocol (PDCP) duplication transmission are confirmed or rejected by the second terminal device, whether the second resources used by the first terminal device to transmit the PDCP duplication transmission are confirmed or rejected by the second terminal device, third resources comprised in the first resources that are confirmed or rejected by the second terminal device, or fourth resources comprised in the second resources that are confirmed or rejected by the second terminal device.

In some embodiments, the processor is further configured to cause the network device to: if at least one of the first resources or the second resources is rejected by the second terminal device, transmit, to a first terminal device, a message indicating at least one of the following adjusted first resources or adjusted second resources.

In an aspect, it is proposed a first terminal device comprising: a processor configured to cause the first terminal device to: perform, with a second terminal device, a sidelink (SL) transmission on a plurality of frequencies; and trigger a selection of a frequency of the plurality of frequencies if one of the following: the number of negative acknowledgement (NACK) associated with the frequency is larger than or equal to a first threshold number, a first channel busy ratio (CBR) value associated with the frequency measured by the first terminal device is larger than or equal to a first threshold value, a second CBR value associated with the frequency measured by the second terminal device is larger than or equal to a second threshold value.

In some embodiments, the processor is further configured to cause the first terminal device to: in response to a success of the re-selection, transmit a message indicating at least the re-selected frequency to the second terminal device or a network device.

In some embodiments, the processor is further configured to cause the first terminal device to: in accordance with a determination that the number of frequencies unavailable for the SL transmission is larger than or equal to a second threshold number, report a radio link failure to a network device.

In some embodiments, one of the first and second terminal device is a transmitter device and the other one of the first and second terminal device is a receiver device.

In an aspect, it is proposed a first terminal device comprising: a processor configured to cause the first terminal device to: determine at least one frequency to be used by the first terminal device for a sidelink (SL) transmission with a second terminal device based on at least one of the following: a first set of frequencies supported by the first terminal device, a second set of frequencies supported by the second terminal device, a first set of channel busy ratio (CBR) measurement results associated with at least part of the first set of frequencies, or a second set of CBR measurement results associated with at least part of the second set of frequencies; and perform, with the second terminal device, the SL communication on the at least one frequency.

In some embodiments, the processor is further configured to cause the first terminal device to: transmit a first configuration indicating the first set of frequencies to the second terminal device; receive a second configuration indicating the second set of frequencies from the second terminal device; and determine an intersection set of first and second sets of frequencies, and wherein the first and second sets of CBR measurement results are associated with the intersection set.

In some embodiments, the processor is further configured to cause the first terminal device to: transmit a first report indicating the first set of CBR measurement results to the second terminal device; and receive a second report indicating the second set of CBR measurement results from the second terminal device.

In some embodiments, the processor is further configured to cause the first terminal device to: transmit information indicating the at least one frequency to the second terminal device or a network device.

In some embodiments, one of the first and second terminal device is a transmitter device and the other one of the first and second terminal device is a receiver device.

In an aspect, a first terminal device comprises: at least one processor; and at least one memory coupled to the at least one processor and storing instructions thereon, the instructions, when executed by the at least one processor, causing the device to perform the method implemented by the first terminal device discussed above.

In an aspect, a network device comprises: at least one processor; and at least one memory coupled to the at least one processor and storing instructions thereon, the instructions, when executed by the at least one processor, causing the device to perform the method implemented by the network device discussed above.

In an aspect, a second terminal device comprises: at least one processor; and at least one memory coupled to the at least one processor and storing instructions thereon, the instructions, when executed by the at least one processor, causing the device to perform the method implemented by the second terminal device discussed above.

In an aspect, a computer readable medium having instructions stored thereon, the instructions, when executed on at least one processor, causing the at least one processor to perform the method implemented by the first terminal device discussed above.

In an aspect, a computer readable medium having instructions stored thereon, the instructions, when executed on at least one processor, causing the at least one processor to perform the method implemented by the network device discussed above.

In an aspect, a computer readable medium having instructions stored thereon, the instructions, when executed on at least one processor, causing the at least one processor to perform the method implemented by the second terminal device discussed above.

In an aspect, a computer program comprising instructions, the instructions, when executed on at least one processor, cause the at least one processor to perform the method implemented by the first terminal device discussed above.

In an aspect, a computer program comprising instructions, the instructions, when executed on at least one processor, cause the at least one processor to perform the method implemented by the network device discussed above.

In an aspect, a computer program comprising instructions, the instructions, when executed on at least one processor, cause the at least one processor to perform the method implemented by the second terminal device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 13. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method, performed by a first terminal device, the method comprising:
transmitting, to a second terminal device, configuration information comprising more than one carrier for transmission; and
performing, with the second terminal device, a packet duplication transmission on the more than one carrier,
wherein:
a radio link failure (RLF) is detected, in a case where a count number associated with physical sidelink feedback channel (PSFCH) reception for each carrier among the more than one carrier is larger than or equal to a configured counter threshold,
a carrier selection is triggered, in a case where not the count number for each carrier among the more than one carrier is larger than or equal to the configured counter threshold and the count number for a carrier among the more than one carrier is larger than or equal to the configured counter threshold.

22. The method of claim 21, the method comprising:
receiving feedback information from the second terminal device, the feedback information indicating whether the configuration information is confirmed or indicated of a failure by the second terminal device.

23. The method of claim 21, wherein
the configuration information comprises a first radio link control (RLC) channel and a second RLC channel for the packet duplication transmission.

24. The method of claim 21, wherein
the packet duplication transmission comprises a signal radio bear (SRB) transmission.

25. The method of claim 21, wherein
a packet duplication for the packet duplication transmission is performed at packet data convergence protocol (PDCP) layer.

26. A method, performed by a second terminal device, the method comprising:
receiving, from a first terminal device, configuration information comprising more than one carrier for transmission; and
performing, with the first terminal device, a packet duplication transmission on the more than one carrier,
wherein:
a radio link failure (RLF) is detected, in a case where a count number associated with physical sidelink feedback channel (PSFCH) reception for each carrier among the more than one carrier is larger than or equal to a configured counter threshold,
a carrier selection is triggered, in a case where not the count number for each carrier among the more than one carrier is larger than or equal to the configured counter threshold and the count number for a carrier among the more than one carrier is larger than or equal to the configured counter threshold.

27. The method of claim 26, the method comprising:
transmitting feedback information to the first terminal device, the feedback information indicating whether the configuration information is confirmed or indicated of a failure by the second terminal device.

28. The method of claim 26, wherein
the configuration information comprises a first radio link control (RLC) channel and a second RLC channel for the packet duplication transmission.

29. The method of claim 26, wherein
the packet duplication transmission comprises a signal radio bear (SRB) transmission.

30. The method of claim 26, wherein
a packet duplication for the packet duplication transmission is performed at packet data convergence protocol (PDCP) layer.

31. A first terminal device, comprising a processor configured to cause the first terminal device to:
transmit, to a second terminal device, configuration information comprising more than one carrier for transmission; and
perform, with the second terminal device, a packet duplication transmission on the more than one carrier,
wherein:
a radio link failure (RLF) is detected, in a case where a count number associated with physical sidelink feedback channel (PSFCH) reception for each carrier among the more than one carrier is larger than or equal to a configured counter threshold,
a carrier selection is triggered, in a case where not the count number for each carrier among the more than one carrier is larger than or equal to the configured counter threshold and the count number for a carrier among the more than one carrier is larger than or equal to the configured counter threshold.

32. The first terminal device of claim 31, comprising the processor configured to cause the first terminal device to:
receive feedback information from the second terminal device, the feedback information indicating whether the configuration information is confirmed or indicated of a failure by the second terminal device.

33. The first terminal device of claim 31, wherein
the configuration information comprises a first radio link control (RLC) channel and a second RLC channel for the packet duplication transmission.

34. The first terminal device of claim 31, wherein
the packet duplication transmission comprises a signal radio bear (SRB) transmission.

35. The first terminal device of claim 31, wherein
a packet duplication for the packet duplication transmission is performed at packet data convergence protocol (PDCP) layer.
